(19) United States
(12) Patent Application Publication
(10) Pub. No.: US 2008/0027602 A1
(43) Pub. Date: Jan. 31, 2008

(54) System and method for deterring theft of vehicles and other products having integral computer means

(76) Inventors: Tet Hin Yeap, Ottawa (CA); Thomas Anton Goeller, Munich (DE)

Correspondence Address: ADAMS PATENT & TRADEMARK AGENCY, P.O. BOX 11100, STATION H, OTTAWA, ON, K2H 7T8, CA

(21) Appl. No.: 11/806,247

(22) Filed: May 30, 2007

Related U.S. Application Data
(60) Provisional application No. 60/808,967, filed on May 30, 2006.

(51) Int. Cl. G06F 19/00

(52) U.S. Cl. 701/29

(57) ABSTRACT

A security system and method for deterring theft of a product, especially an automotive vehicle, is provided. In an embodiment, a secure storage device is provided that can be presented to a vehicle computer. The secure storage device includes a digital certificate associated with the vehicle and is operable to automatically install the certificate on the vehicle's computer once presented to the computer. At this point the vehicle's computer checks whether the certificate is valid and is issued by the private enterprise certificate authority of the vehicle manufacturer. If it is valid, the vehicle's computer then presents the certificate to the software upgrade server of the vehicle manufacurer. The upgrade server checks its certificate revocation list to see if the certificate has been revoked, perhaps because the vehicle is in a list of reported stolen vehicles. If the vehicle is not in the list i.e., its certificate is still valid, the server then allows for authorization of a fully autonomous online download (can be confirmed, if desired) and the secure authentication of such activities. If the vehicle is in the list of reported stolen vehicles, the server performs an exceptional handling process to prevent any software upgrade to the vehicle and reports the incident to the administrator to take firer action. The main vehicle computer may disable the stolen vehicle completely if the vehicle does not get its software upgraded for a predetermined period of time from an authorized server.

### CROSS-REFERENCE TO RELATED APPLICATION

This application claims priority from U.S. Provisional patent application No. 60/808,967 filed May 30, 2006, the contents of which are incorporated herein by reference.

### BACKGROUND OF THE INVENTION

1. Technical Field

The present invention relates to a system and method for deterring theft of land, sea and air vehicles, or other portable or readily transportable products having integral computer means controlling components and/or functions of the product, and is especially applicable to a method and system for deterring theft of automotive vehicles.

2. Background Art

As a result of the proliferation of computers, many kinds of products now include a computer, e.g., a microprocessor, which controls many, if not all of the product's functions. Many of these products, such as laptop computers and personal digital assistants, are portable, while others, such as motor vehicles, boats and aircaft, are transportable. Consequently, there is a likelihood that they will be stolen.

Newer motor vehicles, such as sports utility vehicles and luxury vehicles, frequently are stolen to be shipped off-shore and resold in markets abroad. Three to eight year old vehicles are generally stolen for their parts. Vehicles are also stolen to be used in crimes and for joyriding.

Most approaches to dealing with this problem rely upon deterrence, and fall into one of the following five product categories:

1. Vehicle making schemes which involve marking some unique identifier on vehicle parts to make the vehicle traceable. This may deter thieves who plan to dismantle or resell the vehicle, but not opportunity thieves, such as joyriders.

2. Mechanical barriers on controls, such as a locking telescopic bar which the driver attaches to the steering wheel or footpedal of the vehicle. They work well, but their problem is the vehicle owner has to set them every time the vehicle is parked. This soon becomes inconvenient especially if the owner enters and leaves the vehicle on a regular basis.

3. Vehicle alarms which are, in effect noisemakers; they are annoying and are often ignored.

4. Tracking systems which use a transmitter hidden in the vehicle that emits a signal. The vehicle owner pays a monthly fee for a company to monitor the signal. The system will not, however, prevent the vehicle from being driven away in the first place.

5. Vehicle immobilizers which are electronic devices that arm automatically once the vehicle is shut down (called passive arming) and which prevent the vehicle from being started and driven away. They cut vital circuits in the vehicle. To disarm the system a special key or code is required.

Of these five product categories, the vehicle immobilizers are the most cost-effective deterrent against vehicle theft. Therefore, they are mostly installed as original equipment on late-model vehicles.

One of the key features of a vehicle immobilizer is that it cuts at least three primary circuits, such as the starter, ignition and fuel supply. This feature is only applicable, however, when the thief has little time to tinker with the electronics in the vehicle. Consequently, vehicle immobilizer products do not provide adequate deterrence against organized opportunity vehicle thieves who simply steal the vehicle and transport it in an enclosed container to a garage where their in-house electronic experts disable the vehicle immobilizer.

### SUMMARY OF THE INVENTION

An object of the present invention is to overcome or at last mitigate the limitations of known such theft deterrence systems and methods, or at least provide an alternative. To this end, the present invention provides a system and method for deterring theft of products, such as expensive automobiles, which have an integral computer which controls one or more components and/or functions of the product, in which the integral computer is programmed to require periodic validation of a separate computer-readable security certificate issued to the product owner, the certificate being presented to the integral computer and checked thereby by means of public-private key communication with a secure server, and to disable one or more of said components and/or functions in the event that such validation does not occur.

According to one aspect of the present invention, there is provided a secure system for providing firmware upgrades for a vehicle having an integral computer for controlling one or more components and/or functions of the vehicle and programmed with said firmware, the system comprising:

at a service location, a network interface device coupled to a public data network and having an input port for connection to said integral computer;

an upgrade computer connected to the public data network for delivering upgrades to said integral computer via the public data network;

a security certificate authority means connected to the upgrade computer for storing security certificate information for said vehicle, including validity status of a security certificate unique to said vehicle, and communicating said validity status to said upgrade computer in response to a request received therefrom; and

a computer-readable secure storage device containing a public-key certificate for said vehicle;

the vehicle computer having a port to receive the computer-readable secure storage device;

the vehicle computer being operable to read the public-key certificate information from the received storage device and convey same to the upgrade computer via said network interface device;

the upgrade computer being operable to validate the certificate with the security certificate authority means and, if valid, download firmware upgrade software to the vehicle computer.

Preferably, the upgrade computer is operable following validation of the certificate, to transmit to the vehicle computer a session key used to encrypt the upgrade software, the vehicle computer being operable to use the session key to decrypt the download upgrade software prior to installation.

In the context of this specification, the term “firmware” is intended to embrace software that is stored semi-permanently in the vehicle computer and can be updated or even upgraded periodically by means of an external computer.

Securing the software upgrade distribution chain in this way will deter theft and re-sale of expensive vehicles because their new owners will not be able to keep the firmware up to date. Consequently, since newer vehicles have a considerable software content which needs frequent upgrade, the value of a stolen vehicle will quickly decrease when a number of firmware upgrades have not been performed.

In preferred embodiments of this aspect of the invention, however, the theft deterrence effect is enhanced by programming the vehicle computer to disable at least one component or function of the vehicle, in the event that the firmware has not been upgraded within a predetermined period of time, or a predetermined number of upgrades have been missed. The vehicle computer may be programmed to disable one or more inessential components or functions of the vehicle, such as its entertainment centre, before immobilizing the vehicle completely by disabling an essential function. The vehicle computer may progressively disable several inessential functions before immobilizing the vehicle, and as the inessential functions are being disabled, display or sound a warning to the effect that the components or functions are being disabled or the vehicle about to be immobilized.

The vehicle computer may be programmed to immobilize the vehicle, and/or the inessential functions, by deleting the associated firmware, so that the functionality can be restored subsequently by downloading and installing replacement firmware.

According to a second aspect of the present invention, there is provided a method of providing firmware upgrades for a vehicle having an integral computer for controlling at least one component or function of the vehicle and programed with said firmware, and an associated secure storage device storing a security certificate unique to said vehicle, the method comprising the steps of:

at a service location having a network interface device coupled to a public data network, coupling the vehicle computer to an input port of the interface device and said computer-readable secure storage device with a port of the vehicle computer;

reading the security certificate information and communicating same via said public data network to an upgrade computer at a remote location;

at the upgrade computer, communicating with a security certificate authority means to determine validity status of the security certificate and, if the certificate is valid, downloading the upgrade software to the vehicle computer by way of the public data network and network interface device; and

at the vehicle computer, using the upgrade software to upgrade the computer firmware.

Preferably, following validation of the security certificate, a session key used to encrypt the upgrade software is transmitted to the vehicle computer and used to decrypt the downloaded upgrade software for installation.

According to a further aspect of the invention, there is provided a secure storage device having means for coupling to a vehicle computer and storing security certificate information unique to that particular vehicle.

According to yet another aspect of the invention, there is provided a vehicle computer programmed with software enabling upgrading of the software/firmware by means of a secure certificate system, including reading a secure storage device presented to the vehicle computer and validating a security certificate storage thereon by means of a remote upgrade software received from the upgrade server using an encryption key from an upgrade server and installing the upgrade software.

Preferably, the vehicle computer is programmed to disable one or more components or functions of the vehicle, or even immobilize the vehicle if the software has not been upgraded within a predetermined time period, or a predetermined number of upgrades have been missed.

The vehicle computer may disable one or more inessential components or functions of the vehicle before safely immobilising the vehicle completely. The vehicle computer may also cause a warning to be displayed or sounded to the effect that disabling of a component or function or immobilizing of the vehicle is imminent.

According to still a further aspect of the invention, there is provided an upgrade server computer for supplying upgrade software to a vehicle computer integral to a particular vehicle and having a separate security certificate bearing storage device associated therewith, the upgrade computer being programmed to communicate with the vehicle computer using a public/private key security certificate system to validate the security certificate bearing storage device before providing said upgrade.

Preferably, having validated the security certificate bearing storage device, the upgrade computer supplies an encryption key to the vehicle computer and then encrypts the upgrade software using the encryption key before transmitting the encrypted upgrade software to the vehicle computer.

The foregoing and other objects, features, aspects and advantages of the present invention will become more apparent from the following detailed description, in conjunction with the accompanying drawings, of a preferred embodiment of the invention which is described by way of example only.

### BRIEF DESCRIPTION OF DRAWINGS

A preferred embodiment will now be described by way of example only, and with reference to the accompanying drawings, in which:

FIG. 1 is a schematic representation of an automotive security system to deter automotive theft;

FIG. 2 shows the content of a secure storage device of FIG. 1 in greater detail;

FIG. 3 shows a flowchart depicting a method performed by a vehicle computer to verify certificate stored by a secure storage device presented thereto;

FIG. 4 shows a flowchart depicting operations carried out by the vehicle computer and an upgrade server when verifying whether the vehicle is authorized for a software upgrade;

FIG. 5 shows a flowchart similar to that depicted in FIG. 3 but for an alternative method of verifying a certificate without use of a password; and

FIG. 6 shows a flowchart depicting operation of the vehicle computer to disable the vehicle if required upgrades have not been performed.

### DESCRIPTION OF PREFERRED EMBODIMENTS

Software is taking a leading role in automotive development and innovation. The next generation of premium vehicles is expected to host a cumulated amount of up to one gigabyte of binary code of software deployed via a set of embedded platforms. Already, the cost for software and electronics in current premium vehicles is up 40% of the overall cost. No longer are the software applications limited to classic embedded control systems, such as airbag control software; nowadays applications include a broad range of functions from mission-critical control of engine performance to operation of entertainment systems installed in the vehicle.

Automotive software is complex and usually requires frequent software upgrades/updates. Typically, such upgrades are performed when a vehicle is returned to the dealership for routine service or following a factory recall. The vehicle computer is connected to an upgrade server which downloads the required upgrade(s). Until now, vendors concentrated mainly upon securing the workshop equipment and the software used to download upgrades against theft and unauthorized use. Preferred embodiments of the present invention, however, allow for authorization of garage-requested or fully autonomous online download (can be confirmed, if desired) and the secure authentication of such activities. This facilitates faster rollout of software corrections as well as protection of software upgrades on individual vehicles, together with many other useful functionalities provided by a single infrastructure.

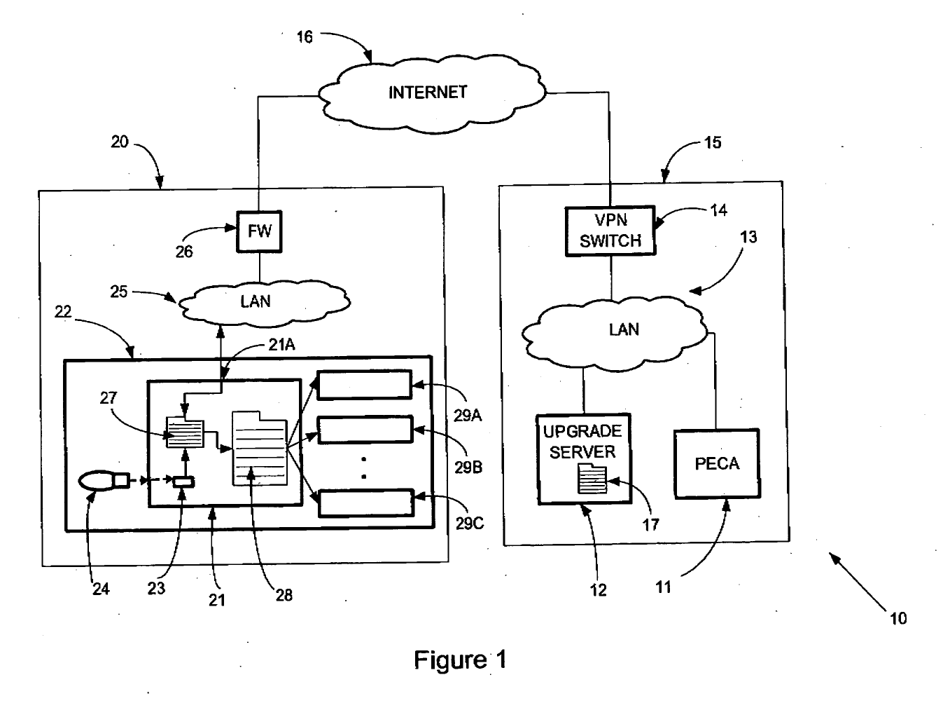

Referring now to FIG. 1, a security system indicated generally at 10 comprises a Private Enterprise Certificate Authority (PECA) 11 that is connected to an upgrade computer server 12 via a local private network 13. In turn, the local private network 13 connects to a public data network 16, e.g., the Internet via a VPN (Virtual Private Network) switch 14 (and/or an Intranet and/or another other type of network that may be desired). The PECA 11 and upgrade server 12 conveniently are permanently located at the company's headquarters 15, or any other suitable location.

A local area network (LAN) 25 at a vehicle service location 20, for example the garage of a motor vehicle dealership, also is connected to the public data network 16. The LAN 25 may be protected by a firewall 26 or may be connected directly to the public data network 16. An on-board computer 21 in a vehicle 22 can be connected by way of a suitable data port 21A to the local area network (LAN) 25. In addition to its firmware used for operating the vehicle's systems, the vehicle computer 21 is programmed with Virtual Private Network (VPN) Client software enabling it to communicate with the manufacturers upgrade server 12, by way of the Internet 16, the VPN switch 14, and the private network 13. Although the basic communications system and the manner in which it operates will be known to those skilled in the art, a feature of the system 10 embodying the present invention is that it employs a public-private key certification system to ensure that the software upgrades are only delivered to the vehicle if the vehicle identity is properly authenticated and authorized, as will be described more particularly below.

A part of the system 10 comprises a secure storage device 24 that can be presented to a service port 23 on the vehicle computer 21. As illustrated in FIG. 1, in the vehicle computer 21 there are two main software codes: vehicle function control firmware 28 and firmware upgrade control software 27. Vehicle function control firmware 28 controls various functions of the vehicle, such as engine and drive train system 29A, accessory system 29B and entertainment system 29C. In addition, for reasons which will be described later, it includes software enabling it to disable inessential vehicle functions or components progressively, and then disable the vehicle completely, i.e. disable an essential function of the vehicle. It also includes a software module for decrypting upgrade software using a session/encryption key received from the upgrade server 12, as will be described in more detail later.

The firmware upgrade control software 27 provides a secure and authenticated connection between the vehicle computer 21 and the firmware upgrade server 12 via the public data network (e.g. Internet) 16 and the VPN switch 14. It controls the vehicle firmware upgrade when it receives permission and upgrade data from the firmware upgrade server 12. To determine whether the firmware upgrade is correct and permissible for that particular vehicle, the on-board computer receives private vehicle data from the secure storage device 24 when the secure storage device 24 is introduced to the vehicle computer via port 23. In this preferred embodiment, secure storage device 24 has a form factor consistent with a USB and includes a Universal Serial Bus (“USB”) connector, so it can connect to a USB-based service port 23 on vehicle computer 21. In other embodiments, however, the secure storage device can be based on other types of wired or wireless interfaces, such as RS-232, Infrared, Bluetooth etc.

Traditionally, a certificate used in a public-private key security system comprises a block of information in standard format that contains a public key as well as information about the person to whom it was issued, information about the organization that issued the certificate, and the date until which it is valid. It is currently the best choice for authenticating a person and also for defining the scope of operations allowed for the person, thus providing an easy-to-manage access control system for client and server.

A PECA, such as PECA 11, is deployed in an enterprise to allow certificates to be issued only to those users who are trusted members of the group. It provides better security than a third party certificate authority in enterprise applications since administrators could control who may own certificates, and therefore who may access the organization's resources. The use of a PECA does not require interfaces external to the enterprise; thus a PECA can significantly reduce certificate cost and ease process integration for a large number of private users needing certificates for client authentication.

In the embodiment of this invention illustrated in FIG. 1, however, the public-private key certificate and the PECA 11 are used differently, in so far as they are deployed as an assurance that the person holding the secure storage device 24 is indeed the owner of the vehicle or someone to whom the owner has given the secure storage device 24. Secure storage device 24 contains a certificate. For every vehicle manufactured by the company, a secure storage device 24 unique to that vehicle is loaded with data files 31 that are unique to the assigned vehicle. The unique secure service key 24 is given to the owner when taking delivery of the vehicle. Alternatively, a defined number of secure storage devices 24 may be issued to the legitimate users of the vehicle, each key containing a unique combination of data identifying the person and the vehicle.

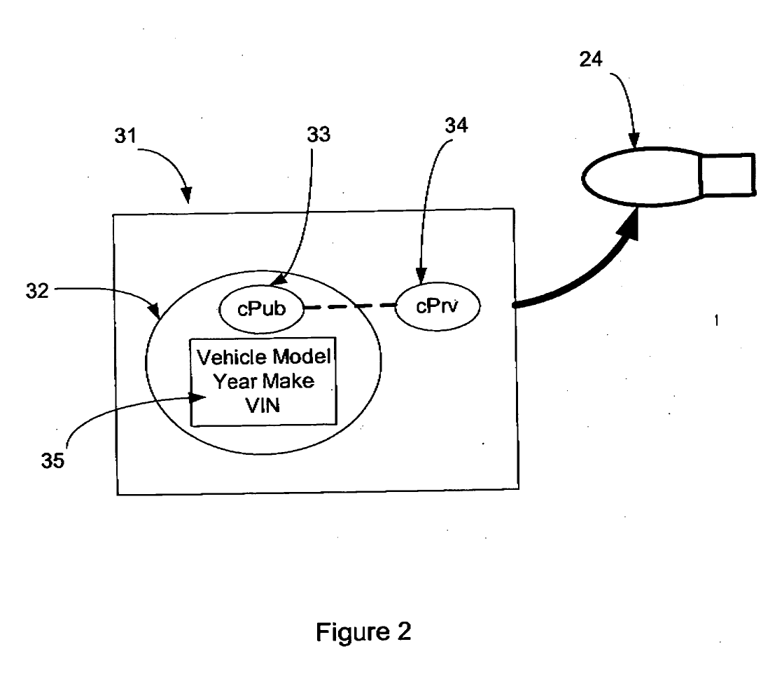

As shown in more detail in FIG. 2, data files 31 include a digital certificate 32 which has been generated uniquely for the vehicle. (If several certificates have been issued for the vehicle, each certificate is generated uniquely for the combination of vehicle and user.) The digital certificate 32 is generated by PECA 11 and will thus contain a public key (cPub) 33 that is uniquely associated with that vehicle and a variety of other vehicle identification information such as model, year of manufacture and Vehicle Identification Number (VIN) for that particular vehicle. Data files 31 also contain a private key (cPrv) 34 that corresponds to the public key (cPub) 33. The private key (cPrv) 34 typically is encrypted by an owner's password PW or personal identification number (PIN). Such a password PW can be used for local authentication on a local computer in the service location/station when the owner brings in the vehicle for maintenance service. If no such local authentication is needed, then the private key (cPrv) 34 is stored in clear inside secure service key 24. This will be discussed as an alternative embodiment later.

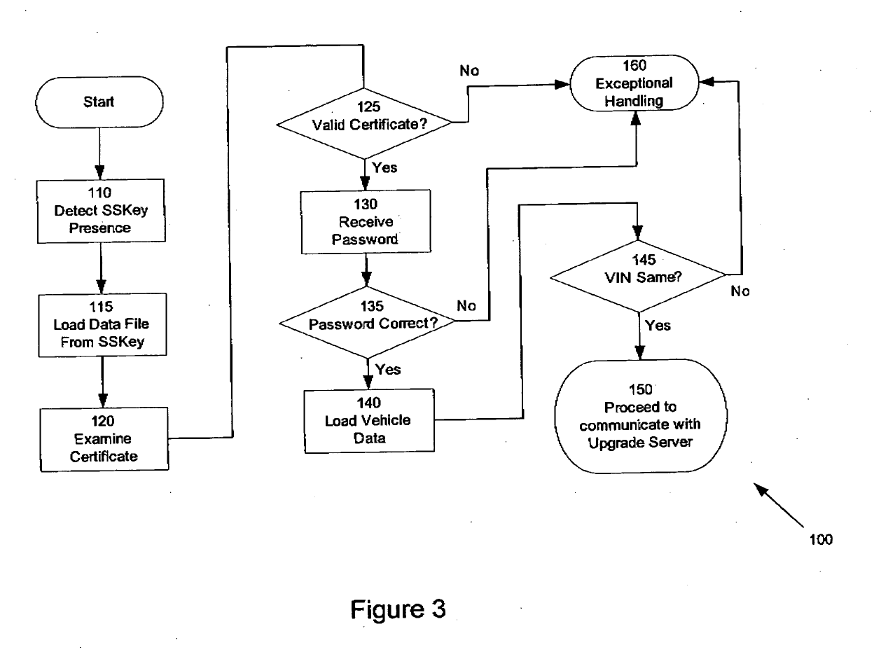

When an owner delivers his vehicle to the service location (garage) 20 for service, he will also take his secure storage device 24. The service technician inserts the secure storage device 24 into the service port 23 of the vehicle computer 21 before he begins the service. As depicted in FIG. 3, at step 110, the vehicle computer 21 detects the presence of secure storage device 24 and at step 115 loads the certificate 32 and an encrypted private key (cPrv) 34 stored in the key 24. At steps 120 and 125, the vehicle computer 21 checks whether the data certificate 32 is valid and is issued by the PECA 11 of the vehicle company. If decision step 125 is negative, i.e., the certificate 32 is not valid, the vehicle computer 21 will advance to step 160 for exceptional handling. It should be noted that the type of exceptional handling provided at step 160 is not particularly limited and can be configured according to the desired security parameters of system 10.

If the result of decision step 125 is positive, at step 130, the vehicle computer 21 receives the password PW provided by the owner, conveniently by entering it by means of a keypad of the kind used by service technicians to communicate with vehicle computers, and determines whether or not it is correct, i.e., is able to decrypt the encrypted private key cPrv stored on the secure storage device 24, the owner having been given the password with the secure storage device 24, typically when taking delivery of the vehicle. If decision step 135 is negative, i.e., a correct password was not received in step 130, the vehicle computer 21 will advance to step 160 for exceptional handling.

If, at steps 130 and 135, the correct password is provided by the owner, thus providing 2-factor authentication, the private key cPrv 34 is decrypted using the password PW, so that the pair of keys (cPrv) 34 and (cPub) 33 are available for communication with server 12 for software upgrade later. At step 140, the vehicle computer 21 decodes vehicle information from the certificate 32 and at step 145 determines whether the vehicle data, such as the VIN and the model, in the certificate match the VIN and model information stored permanently in flash memory (not shown) in the vehicle computer 21. If the result of decision step 145 is negative, i.e., the information, especially the VIN, does not match, the vehicle computer will advance to the step 160 for exceptional handling.

If the information in the certificate 32 and the information in the flash memory of the vehicle computer 21 match each other, then the vehicle computer 21 proceeds to step 150 to set up secure communications between the vehicle computer 21 and the upgrade server 12.

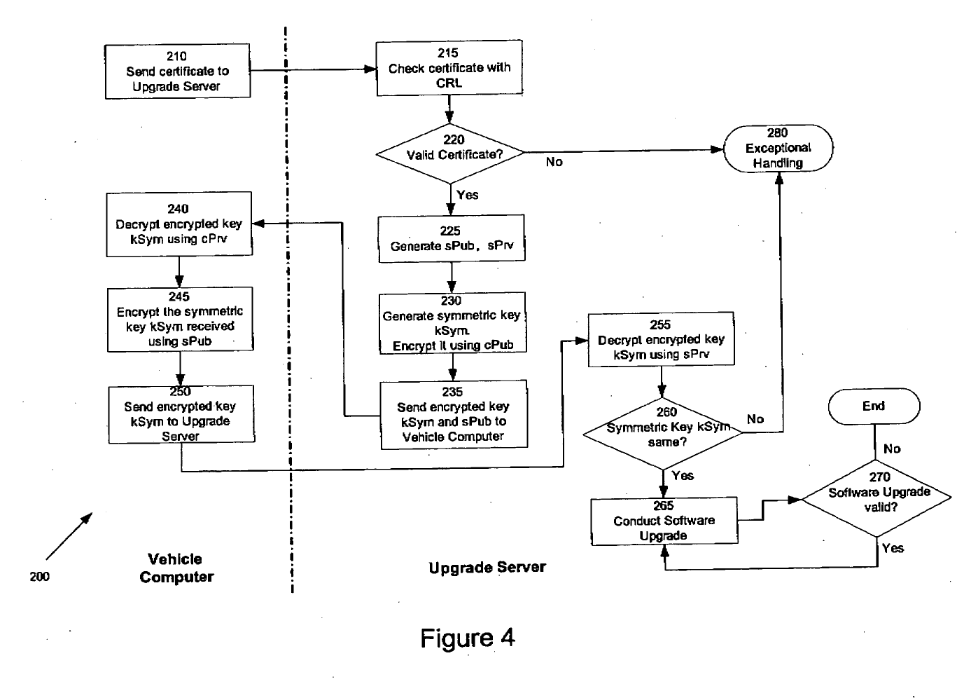

FIG. 4 is a flowchart illustrating the ensuing communications between the vehicle computer 21 and upgrade server 12 as the vehicle computer requests a software upgrade. Thus, once it has been authorized and communications with the upgrade server 12 established, in step 210 the vehicle computer 21 presents the public certificate 32 obtained from the secure storage device 24 to the server 12. At step 215, the server 12 examines the contents of certificate 32 and compares them with a certificate revocation list (CRL) 17 located in server 12. The CRL 17 is published by PECA 11. In decision step 220, the server 12 determines whether or not the certificate is valid, i.e., it belongs to the list of issued certificates. If certificate 32 is not valid, because it has not been issued by PECA 11, or has been issued by PECA 11 but later revoked, the server will proceed to step 280 and initiate exceptional handling. So, even when the vehicle has not been reported as stolen and the certificate has not yet been revoked, the server 12 can notify potential theft of a vehicle to a registered owner, vendor or to the police. This is particularly useful when the vehicle is not regularly used, e.g. when it is parked at a secondary residence.

If, in step 220, the certificate 32 is found to have been revoked according to the CRL 17 information, then it will be advanced to step 280 for exceptional handling. The type of exceptional handling at step 280 is not particularly limited and can be configured according to the desired security parameters of system 10. For example, if desired, at this point the server may send a signal to an administrator indicating that someone has tried to use a secure storage device 24 that contains a revoked certificate or a certificate that has not been issued by PECA 11. In any event, the server 12 will not proceed to step 225 and will not allow the vehicle computer 21 to download a software upgrade.

If, however, decision step 220 is positive, indicating that certificate 32 is valid, then method 200 advances to step 225 at which point asymmetric session keys namely, server private key (sPrk); and server public key (sPub), are generated by server 12. At this point, method 200 advances to step 235 and proceeds to set up a symmetric communication session from the vehicle computer 21 to server 12 by using server public and private key pair sPub, sPrv and vehicle computer public and private key pair cPub, cPrv.

The key exchange process is known to those of skill in the art, but such symmetric access will be more particularly described below as an example. At step 230, the server 12 generates a random symmetric key kSym and encrypts it with the public key (cPub) 33. In step 235, the encrypted key and the public key (sPub) are then sent to the vehicle computer 21. At step 240, the vehicle computer 21 decrypts the encrypted symmetric key kSym received from the server 12 using its private key cPrv. In steps 245 and 250, respectively, the vehicle computer 21 then encrypts the symmetric key kSym by the server's public key (sPub) and sends it back to the server 12. In step 255, the server 12 decrypts the encrypted key from the vehicle computer 21 using the server's private key (sPrv). In step 260, the server 12 then compares the decrypted key from the vehicle computer 21 with its own copy of symmetric key kSym. If the two keys are the same, then the server 12 knows that the symmetric key for the software upgrade has been setup and the method 200 proceeds to step 265 to start the software upgrade operation. If decision step 260 is negative, however, i.e., the keys are not the same, the server 12 will advance to step 280 for exceptional handling. It should be noted that the type of exception handling at step 280 is not particularly limited and can be configured according to the desired security parameters of system 10.

Method 200 then cycles between steps 265 and 270, periodically executing step 270 so a determination can be made as to whether the software upgrade session is still valid. As long as the software upgrade session is still valid, method 200 will return to step 265. If decision step 270 is negative, and the session is invalid, then method 200 will end, causing the symmetric session key to expire and otherwise preventing any further communications between the vehicle computer 21 and the server 12.

A variety of criteria can be used at step 265 to determine whether the software upgrade session remains valid. In particular, if a predefined period of inactivity passes, during which no communications are conducted at step 265, then it might be desired to terminate the software upgrade session, expire the symmetric session keys, and end method 200. By the same token, it might be desired simply to expire the software upgrade session after a complete upgrade code has been transmitted, regardless of whether there has been inactivity. Other criteria will now occur to those of skill in the art.

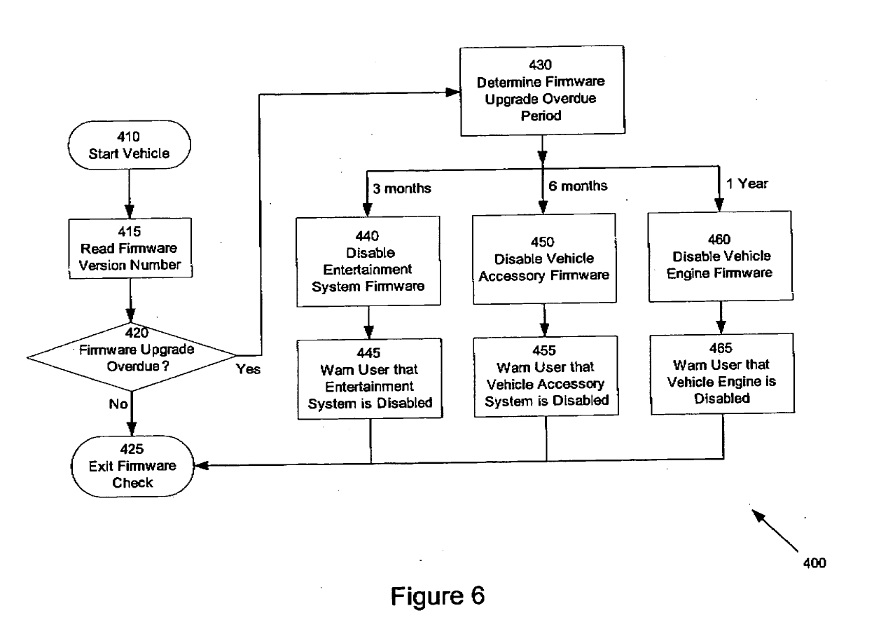

As mentioned hereinbefore, if the firmware upgrades are not performed in a timely manner, the vehicle computer 21 will progressively disable functions or components until, if permitted by law and providing it can be done safely, the parked vehicle is immobilised, if convenient via the burglar alarm, if installed. Such a sequence of events is depicted in FIG. 6. Thus, each time the vehicle is started, as in step 410, the vehicle computer reads the firmware version number in step 415 and in step 420 determines whether or not the firmware is current, either by checking an expiry date on the firmware or by reference to standard upgrade intervals or by communication with the upgrade server 12. If the firmware is current, the program exits at step 425.

If step 420 reveals that an upgrade is overdue, in step 430 the program determines the interval by which the upgrade is overdue. If the overdue interval is less than three months, in step 440 the program disables the entertainment system and in step 445 initiates the display of a warning that the entertainment system has been disabled because the software upgrade is overdue. If the overdue interval is between three months and six months, in step 450 the program disables another component or accessory, such as interior lighting, and in step 455 initiates the display of a second warning. If the overdue interval is between six months and one year, in step 460 the program immobilizes the vehicle, possibly by preventing starting of the engine, and in step 465 initiates the display of a message advising why the engine has been disabled or vehicle immobilized. It will be appreciated that the engine might only be disabled while the vehicle was parked so as to avoid compromising the safety of the occupants. If the local law precluded disabling the engine, some other means of immobilizing the vehicle could be employed, for example by inhibiting the ignition sequence. If a suitable burglar alarm is installed, the vehicle computer might use the burglar alarm to immobilize the vehicle. It is envisaged that the password PW could be dispensed with. In some cases, the vendor does not want to require the owner of the vehicle to keep track of the password for encrypting the private key (cPrv) 34 stored in secure storage device 24.

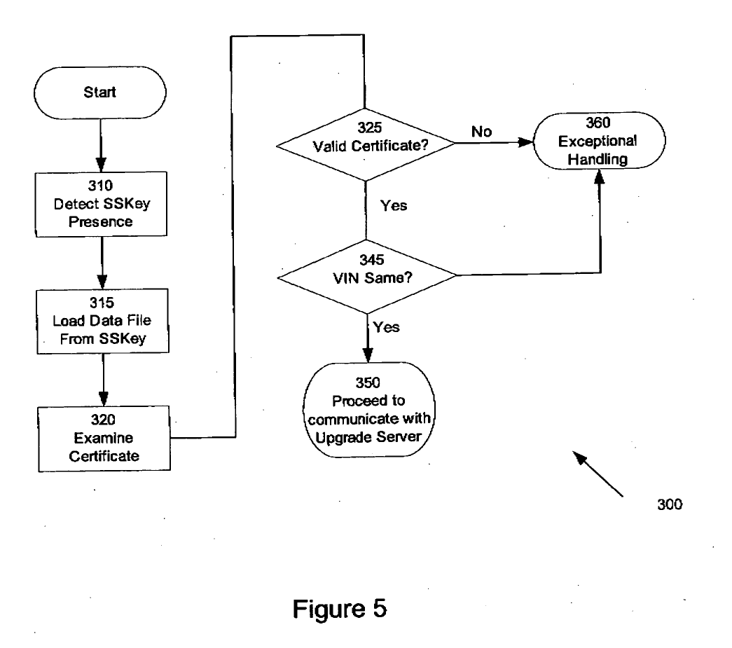

It is sufficient then for the owner to take the vehicle's secure storage device 24 along when taking the vehicle for software upgrade during a regular service. Without the secure service key 24, no software upgrade could be performed, thus deterring any possibility of vehicle theft. Therefore, in another embodiment, it is desirable to store the private key cPrv 34 in clear inside secure service key 24. Reference will now be made to FIG. 5 which shows a method 300 for verify the certificate is valid. The service technician inserts the secure service key 24 into the service port 23 of the vehicle computer 21 before he begins the service. At step 31 0, the vehicle computer 21 detects the presence of secure service key 24 and loads the certificate 32 and the private key cPrv 34 stored in the key at step 315. At steps 320 and 325, the vehicle computer 21 checks whether the data certificate 32 is valid and is issued by the PECA 11 of the vehicle company. If the certificate 32 is not valid, it will advance to step 360 for exception handling. At step 345, the vehicle computer 21 decodes the vehicle information from the certificate and determines whether the vehicle data such as the VIN and the model in the certificate match those VIN and model information stored permanently in flash memory in the vehicle computer. If both the information in the certificate and flash memory of the vehicle computer matches each other, then it proceeds to the next step 350 to proceed with the secure communications setup between the vehicle computer and the server 12 setup. Otherwise the vehicle computer will advance to the next step 360 for exception handling.

In many cases, it is difficult to manage the distribution of the secure storage device 24 by the vehicle manufacturer during a vehicle sale; or in some cases it is difficult for the owner to keep track of where the secure storage device 24 is. It is envisaged, therefore, that the separate secure storage device 24 could be integrated into the vehicle's ignition key. In normal conditions, the owner needs to the ignition key to drive the vehicle. During a regular maintenance service, the ignition key will be used instead of the secure storage device 24 in FIG. 1 for authenticating a software upgrade. In a stolen vehicle, it is most likely that the thief does not have the proper ignition key to authenticate a software upgrade. Without software upgrade, the vehicle is virtually useless after the software in the vehicle computer is disabled.

The ignition key or, if provided, separate secure storage device 24, may communicate with the vehicle computer 21 by any suitable communications channel, including wired or wireless interfaces such as Infrared, Bluetooth etc. These communications channels are well known to those skilled in the art and need not be described herein.

For clarity, the foregoing description of the secure upgrade procedure assumed that the method 100 illustrated in FIG. 3 was operated by the vehicle computer 21 in conjunction with the insertion of the secure service key 24 in service port 23 of the vehicle computer 21. It is to be understood, however, that system 10 and/or method 100 can be varied, and need not work exactly as discussed herein in conjunction with each other, and that such variations are within the scope of the present invention.

It is to be understood that system 10 and/or method 100 and/or method 200 can be varied, and need not work exactly as discussed herein in conjunction with each other, and that such variations are within the scope of the present invention.

It should be noted that, even though VPN switch 14 protects the server 12 from any hacker attack from the public internet 16, a secure communication channel needs to be set up directly between the vehicle computer 21 and the server 12. Otherwise data would be available in the clear in the private network 25 and could be accessed by a vehicle thief.

Additionally, while the embodiments herein show specific configurations of vehicle computers that can be operated by a service technician accessing the software upgrade server with proper authentication, it is to be understood that different configurations of vehicle computers and servers are contemplated. For example, the secure software upgrade may not be initiated from a garage. It could be initiated autonomously by the vehicle computer, polling a software upgrade server whenever it has network connectivity. This may be a case when the vehicle is provided with wireless connectivity to a public network.

It should be noted that the vehicle manufacturer will issue the security certificate for each new vehicle and store a copy on the PECA server 11. Hence, there will be numerous such certificates stored on the server 11. When a certificate is revoked, perhaps because the vehicle has been reported as stolen, or following suspicious activity such as a failed attempt to access the upgrade server 12, that certificate will be transferred to a “revoked certificates” list. When validating the certificate of a particular vehicle for which an upgrade is being sought by the upgrade computer server 12, the PECA 11 will access the revoked certificates list.

It is envisaged that the system could be arranged to send a notification to the owner, the vendor or the police, giving an indication of a potential vehicle theft, if a configurable number of unauthorized software upgrade attempts were made over a certain period trigger. Moreover, regardless of the availability of a new software upgrade, the vehicle software can check locally and remotely whether the vehicle user has used an authorized key to access the vehicle, and if not, can proceed to further action, such as, but not restricted to: connecting to a police computer and transmitting the location of the vehicle with the help of GPS information from the navigation system reduce or cease to make vehicle services available in a safe fashion issue a warning sound or a warning display a warning or generate an audible warning flash the warning lights.

Besides being used for the functionality described hereinbefore, the system may be used for well-known functionalities, such as but not restricted to: access to the vehicle (vehicle key), by using the key code with a form of proximity transmission such as but not restricted to infrared, Bluetooth, near-field transmission, authentication and authorization of billing for services consumed in conjunction with vehicle operation, such as but not restricted to navigation information upgrade information about traffic situation and road conditions, local weather information to find local services provision, download and consumption of media (news, music, video). This reduces the number of components used for authentication, simplifying the usage of the services and reducing the cost connected with it.

It is also envisaged that the software running in the vehicle may be personalized to operation of an individual vehicle (identified by electronic part identifiers or in another way) with one or several vehicle owner keys, so that copying of upgraded software from another vehicle would not enable operation in the individual vehicle.

The secure storage device could be a USB storage device, a so-called “smartcard” or other device capable of coupling to the vehicle computer, either physically or wirelessly, e.g. using a Bluetooth (trademark) link.

The password may take a known form, including the usual alpha-numeric terms. Additionally or alternatively, other authentication means could be used, such as fingerprints or other unique biological identification means.

Embodiments of the invention may facilitate both faster rollout of software corrections as well as protection of software upgrades on individual vehicles are made possible, together with many other useful functionalities provided by a single infrastructure.

It is noted that modern vehicles, especially luxury vehicles, require infrequent servicing. Consequently, it is envisaged that the vehicle computer could be programmed to requite validation of the vehicle software at times unrelated to service intervals or software upgrade intervals and conceivably without requiring connection to a dealer's network. Thus, for example, the vehicle computer could require the secure storage device 24 to be presented, and a validation check performed, every three months, failing which the disablement sequence would commence.

While the various embodiments herein have been discussed in relation to vehicle theft deterrence, it is to be understood that the teachings herein can be more broadly applied to other types of similar application requiring regular software upgrade where security protocols are employed to deter theft. In the context of vehicles, it will be appreciated that the invention is equally applicable to other vehicles, such as boats and private aircraft having an integral computer which controls essential functions of the vehicle and so can render the vehicle useless if timely upgrades do not take place. It is also envisaged, however, that the invention may also be applied to deterring theft of other products that are portable or readily transportable, have an integral computer controlling essential functions and have means for communicating with an integrity server, say via a data network. More and more products have integral computers controlling essential functions. For example, modem washing machines have microcontrollers controlling operation of not only the various washing programmes but also the motor drive. Nowadays, such a washing machine is likely to be used in a home having wireless Internet access. The owner of the washing machine could be issued with a security, certificate storage device by the vendor and keep it in a safe place. Periodically, the owner would be required to present it to the washing machine microcontroller for validation. Failure to do so would result in the microcontroller disabling the machine. If the washing machine were stolen, it would soon cease to operate for failure to validate the security information.

It is also envisaged that the system could be used to deter theft of such products during transportation, say be container. The vendor would send the secure storage device to the purchaser or dealer by a separate route. If the product were stolen en route, it would soon cease to operate if not validated using the secure storage device. In this situation, the integral computer could be programmed to that it would not even commence operation without presentation of the secure storage device containing the security certificate.

It will be appreciated that any disabling of vehicle components or functions, or immobilising of the vehicle, will be carried out in such a way that the safety of the vehicle occupant(s) is not compromised.

The above-described embodiments of the invention are intended to be examples of the present invention and alterations and modifications may be effected thereto, by those of skill in the art, without departing from the scope of the invention which is defined solely by the claims appended hereto.

By controlling regular software upgrades required by a vehicle, embodiments of this invention deter organized opportunity thieves from stealing it, shipping it off-shore and re-selling it in a market abroad. The invention is predicated upon the assumption that a vehicle is given an identity and a certificate based mechanism would be used to authenticate and audit the software upgrade performed upon the vehicle's on-board computer by way of an authorized server. Embodiments of the invention may address either or both of two potential frauds. First, if a stolen vehicle does not get a software upgrade from an authorized server over a period of time, the main vehicle computer will safely disable vehicle functions and/or components. Second, the server would keep track of software upgrade from each vehicle. If too many software upgrades were performed by a certain vehicle identity within a short period, then the server would determine that there could be a potential breach of that vehicle's security/identity and would disable all future software upgrades for that vehicle identity.

Although embodiments of the invention have been described and illustrated in detail, it is to be clearly understood that the same are by way of illustration and example only and not to be taken by way of limitation, the scope of the present invention being limited only by the appended claims.

1. A secure system for providing firmware upgrades for a vehicle having an integral computer for controlling one or more components or functions of the vehicle and progammed with said firmware, the system comprising:
at a service location, a network interface device coupled to a public data network and having an input port for connection to said integral computer;
an upgrade computer connected to the public data network for delivering upgrades to said integral computer via the public data network;
a security certificate authority means connected to the upgrade computer for storing security certificate information for said vehicle, including validity status of a security certificate unique to said vehicle, and communicating said validity status to said upgrade computer in response to a request received therefrom; and
a computer-readable secure storage device containing a public-key certificate for said vehicle;
the vehicle computer having a port to receive the computer-readable secure storage device;
the vehicle computer being operable to read the public-key certificate information from the received storage device and convey same to the upgrade computer via said network interface device;
the upgrade computer being operable to validate the certificate with the security certificate authority means and, if valid, download firmware upgrade software to the vehicle computer.

2. A system according to claim 1, wherein the upgrade computer is operable, following validation of the certificate, to transmit to the vehicle computer a session key used to encrypt the upgrade software, the vehicle computer being operable to use the session key to decrypt the download upgrade software prior to installation.

3. A system according to claim 1, wherein the vehicle computer is operable to disable at least one component or function of the vehicle in the event that the firmware has not been upgraded within a predetermined period of time, or a predetermined number of upgrades have been missed.

4. A system according to claim 1, wherein the vehicle computer is operable to disable one or more functions or components of the vehicle.

5. A system according to claim 4, wherein the vehicle computer is operable to disable several inessential functions progressively before immobilising the vehicle.

6. A system according to claim 5, wherein, while disabling said inessential functions, the vehicle computer causes the vehicle to display or sound a warning to the effect that disabling of a component or function is imminent.

7. A system according to claim 1, wherein the vehicle computer is programmed to disable the vehicle components or functions by deleting the associated firmware, so that the functionality can be restored only by installing replacement firmware.

8. A method of providing firmware upgrades for a vehicle having an integral computer for controlling one or more components or functions of the vehicle and programmed with said firmware, and an associated secure storage device storing a security certificate unique to said vehicle, the method comprising the steps of:
at a service location having a network interface device coupled to a public data network, coupling the vehicle computer to an input port of the interface device and said computer-readable secure storage device with a port of the vehicle computers;
reading the security certificate information and communicating same via said public data network to an upgrade computer at a remote location;
at the upgrade computer, communicating with a security certificate authority means to determine validity status of the security certificate and, if the certificate is valid, downloading the upgrade software to the vehicle computer by way of the public data network and network interface device; and
at the vehicle computer, using the upgrade software to upgrade the computer firmware.

9. A method according to claim 8, wherein, following validation of the security certificate, a session key used to encrypt the upgrade software is transmitted to the vehicle computer and used to decrypt the downloaded upgrade software for installation.

10. A method according to claim 8, wherein the certificate for a particular vehicle is revoked from the authentication list for software upgrades when the vehicle is reported stolen.

11. A method according to claim 8, wherein a configurable number of unauthorized software upgrade attempts over a certain period trigger a notification to the owner, the vendor or the police, giving an indication of a potential vehicle theft.

12. A method according to claim 8, wherein the software of the vehicle is personalized to operation of that vehicle only (identified by electronic part identifiers or in another way) with one or several vehicle owner keys, so that copying of upgraded software from another vehicle would not enable operation in the individual vehicle.

13. A secure storage device having means for coupling to a vehicle computer and storing security certificate information unique to a particular vehicle.

14. A vehicle computer programmed with software enabling upgrading of the software/firmware by means of a secure certificate system, including reading a secure storage device associated with the vehicle validating a security certificate storage thereon by means of a remote upgrade software received from the upgrade server using an encryption key from the an upgrade server and installing the upgrade software.

15. A vehicle computer according to claim 14, programmed to disable one or more functions or components of the vehicle if the software has not been upgraded within a predetermined time period, or a predetermined number of upgrades have been missed.

16. A vehicle computer according to claim 15, operable to disable several inessential components or functions progressively before immobilising the vehicle.

17. A vehicle computer according to claim 16, operable to cause a warning to be displayed or sounded to the effect that disabling of a component or function is imminent.

18. A vehicle computer according to claim 16, programmed to disable the vehicle components or functions by deleting the associated firmware so that the functionality can be restored only by installing replacement firmware.

19. An upgrade server computer for supplying upgrade software to a vehicle computer integral to a particular vehicle and having a separate security certificate bearing storage device associated therewith, the upgrade computer being programmed to communicate with the vehicle computer using a public/private key security certificate system to validate the security certificate bearing storage device before providing said upgrade.

20. An upgrade server computer according to claim 15, wherein the upgrade computer is operable, after validating the security certificate bearing storage device, to supply an encryption key to the vehicle computer and then encrypt the upgrade software using the encryption key before transmitting the encrypted upgrade software to the vehicle computer.

21. An upgrade computer according to claim 19, wherein the upgrade computer is operable to communicate with a private enterprise certificate authority to validate said certificate borne by the secure storage device against a revocation list.

22. An upgrade computer according to claim 20, wherein the upgrade computer is operable to communicate with a private enterprise certificate authority to validate said certificate borne by the secure storage device against a revocation list.

23. A system for deterring theft of a product having an integral computer which controls one or more essential functions of the product, the integral computer being programmed to require periodic validation of a separate computer-readable security certificate issued to the product owner, the certificate being presented to the integral computer and checked thereby by means of public-private key communication with a secure server, and to disable said essential function in the event that such validation does not occur.
